(19) United States
(12) Patent Application Publication
(10) Pub. No.: US 2008/0106201 A1
(43) Pub. Date: May 8, 2008

(54) PLASMA DISPLAY PANEL

(76) Inventors: Chong-Gi Hong, Yongin-si (KR); Tae-Kyoung Kang, Yongin-si (KR)

Correspondence Address: CHRISTIE, PARKER & HALE, LLP, PO BOX 7068, PASADENA, CA, 91109-7068, US

(21) Appl. No.: 11/923,607

(22) Filed: Oct. 24, 2007

(30) Foreign Application Priority Data
Nov. 2, 2006 (KR) 10-2006-0107975

(51) Int. Cl. H01J 17/49

(52) U.S. Cl. 313/587; 313/582; 313/586

(57) ABSTRACT

A plasma display panel including: a front substrate; a rear substrate; address electrodes extending in a first direction on the rear substrate; barrier ribs between the front and rear substrates defining discharge cells; display electrodes extending in a second direction crossing the first direction and corresponding to the discharge cells, wherein the display electrodes include bus electrodes colored a third chromatic color; a dielectric layer on the front substrate, the dielectric layer covering the display electrodes and colored a first chromatic color that is in a subtractive color mixture relationship with the third chromatic color; and a filter disposed on an outer surface of the front substrate, the filter including: a plurality of light guides; and a plurality of non-glare members that are adjacent to the light guides and colored a second chromatic color.

### CROSS-REFERENCE TO RELATED APPLICATION

This application claims priority to and the benefit of Korean Patent Application No. 10-2006-0107975, filed on Nov. 2, 2006, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel having an improved black area ratio and bright room contrast.

2. Description of the Related Art

A plasma display panel (PDP) generates plasma by electrical discharge. Ultra violet (UV) rays radiate from the plasma to excite a fluorescent layer. Images are displayed using red, green, and blue light generated in the fluorescent layer.

A plasma display panel can be used for large displays. Since the plasma display panel is an emissive display element, the plasma display panel reproduces color with high quality and provides a wide viewing angle. Therefore, the plasma display panel displays high quality images. In addition, since plasma display panel manufacturing processes are simpler than those of liquid crystal display (LCD) manufacturing, yield of the plasma display panel is high, and costs of the plasma display panel are low.

The PDPs are classified into direct current (DC) and alternating current (AC) types, according to discharge types. The DC type plasma display panel has a structure in which electrodes are exposed to discharge spaces. Charges move directly between corresponding electrodes.

In the AC type plasma display panel, electrodes are covered with a dielectric layer, and discharge is carried out by wall charges. Recently, the AC type plasma display panel has been widely used.

According to the disposition structure of electrodes, the PDPs can be classified into an opposed discharge type and a surface discharge type. In the opposed discharge type plasma display panel, display electrodes are disposed on the front and rear substrates. Discharge is carried out from the front substrate toward the rear substrate. In the surface discharge type plasma display panel, display electrodes are disposed on the same substrate. Discharge is carried out on one surface of the substrate.

In the aforementioned plasma display panel, the discharge cells are selected by using the memory characteristic of the wall charges. Discharges take place in the selected discharge cells. The discharges are suitably combined to display images.

Specifically, in bright room conditions, external light is reflected by the panel, in addition to the light generated in the discharge cells. As a result, a bright room contrast deteriorates. Accordingly, the image display performance of the plasma display panel deteriorates.

Various attempts to improve the aforementioned image display performance of the plasma display panel have been made. Though methods of improving contrast by increasing black area ratio and improving luminance of the panel by increasing emission efficiency have been used, it is desirable to simplify the manufacturing processes and improve the bright room contrast.

### SUMMARY OF THE INVENTION

An exemplary embodiment according to the present invention provides a plasma display panel of which black area ratio and bright room contrast are improved without additional components.

According to an aspect of an exemplary embodiment of the present invention, there is provided a plasma display panel including: a front substrate; a rear substrate facing the front substrate and spaced apart from the front substrate; a plurality of address electrodes extending in a first direction on the rear substrate; a plurality of barrier ribs between the front substrate and the rear substrate, the barrier ribs defining a plurality of discharge cells; a plurality of display electrodes extending in a second direction crossing the first direction and corresponding to the discharge cells, wherein the display electrodes include bus electrodes colored a third chromatic color; a dielectric layer on the front substrate, the dielectric layer covering the display electrodes and colored a first chromatic color that is in a subtractive color mixture relationship with the third chromatic color; and a filter disposed on an outer surface of the front substrate, the filter including: a plurality of light guides including incident surfaces and emitting surfaces, wherein areas of the incident surfaces are larger than areas of the emitting surfaces; and a plurality of non-glare members that are adjacent to the light guides and colored a second chromatic color.

In the above aspect of an exemplary embodiment of the present invention, the second chromatic color and the third chromatic color may be in a complementary color relationship. In addition, the third chromatic color and the first chromatic color may be in a complementary color relationship. In addition, the second chromatic color may be a shade of blue. The dielectric layer may be colored a shade of blue by adding at least one of manganese (Mn), nickel (Ni), or cobalt (Co) to the dielectric layer. The third chromatic color may be a shade of yellow red. The dielectric layer may be colored a shade of yellow red by adding at least one of copper (Cu), antimony (Sb), or chromium (Cr) to the dielectric layer. The bus electrodes may include a single layer.

According to an aspect of another exemplary embodiment of the present invention, there is provided a plasma display panel including: a front substrate; a rear substrate facing the front substrate and spaced apart from the front substrate; a plurality of address electrodes extending in a first direction on the rear substrate; a plurality of barrier ribs between the front substrate and the rear substrate and defining a plurality of discharge cells; a plurality of display electrodes extending in a second direction crossing the first direction, wherein the display electrodes include bus electrodes colored a third chromatic color; a dielectric layer covering the display electrodes and colored a first chromatic color that is in a subtractive color mixture relationship with the third chromatic color; and a filter on an outer surface of the front substrate, the filter including: a conductive film on the outer surface of the front substrate; and a non-glare layer on the conductive film and colored a second chromatic color.

In the above aspect of an exemplary embodiment of the present invention, the conductive film may include ITO (indium tin oxide) or Copper (Cu), and one side of the conductive film is electrically connected to a ground member. In addition, the second chromatic color and the third chromatic color may be in a complementary color relationship. In addition, the third chromatic color and the first chromatic color may be in a complementary color relationship.

According to an aspect of another exemplary embodiment of the present invention, there is provided a plasma display panel including: a rear substrate; a front substrate facing the rear substrate, the front substrate spaced apart from the rear substrate and colored a second chromatic color; a plurality of address electrodes extending in a first direction on the rear substrate; a plurality of barrier ribs between the front substrate and the rear substrate and defining a plurality of discharge cells; a plurality of display electrodes extending in a second direction crossing the first direction and corresponding to the discharge cells, wherein the display electrodes include bus electrodes colored a third chromatic color; and a dielectric layer covering the display electrodes and colored a first chromatic color in a subtractive color mixture relationship with the third chromatic color.

In the above aspect of an exemplary embodiment of the present invention, the second chromatic color and the third chromatic color may be in a complementary color relationship. In addition, the third chromatic color and the first chromatic color may be in a complementary color relationship.

### BRIEF DESCRIPTION OF THE DRAWINGS

The above and other features and aspects of the present invention will become more apparent by describing in detail exemplary embodiments thereof with reference to the attached drawings in which:

FIG. 1 is a partially exploded perspective view illustrating a plasma display panel according to a first embodiment of the present invention;

FIG. 2 is a cross sectional view taken along the line II-II of FIG. 1;

FIG. 3 is a partial top plan view illustrating an image display region of the plasma display panel according to the first embodiment of the present invention;

FIG. 4 is a hue circle for illustrating complementary color relationships;

FIG. 5 is a partial cross sectional view illustrating a plasma display panel according to a second embodiment of the present invention;

FIG. 6 is a partial top plan view illustrating an image display region of the plasma display panel according to the second embodiment of the present invention;

FIG. 7 is a partial cross sectional view illustrating a plasma display panel according to a third embodiment of the present invention; and

FIG. 8 is a top plan view illustrating an image display region of the plasma display panel according to the third embodiment of the present invention.

### DETAILED DESCRIPTION OF THE EMBODIMENTS

The present invention will now be described more fully hereinafter with reference to the accompanying drawings, in which exemplary embodiments of the invention are shown. As those skilled in the art would realize, the described embodiments may be modified in various different ways, all without departing from the spirit or scope of the present invention. There may be parts shown in the drawings, or parts not shown in the drawings, that are not discussed in the specification as they are not essential to a complete understanding of the invention. Like reference numerals designate like elements throughout the specification.

Hereinafter, a plasma display panel according to exemplary embodiments of the present invention will be described in detail.

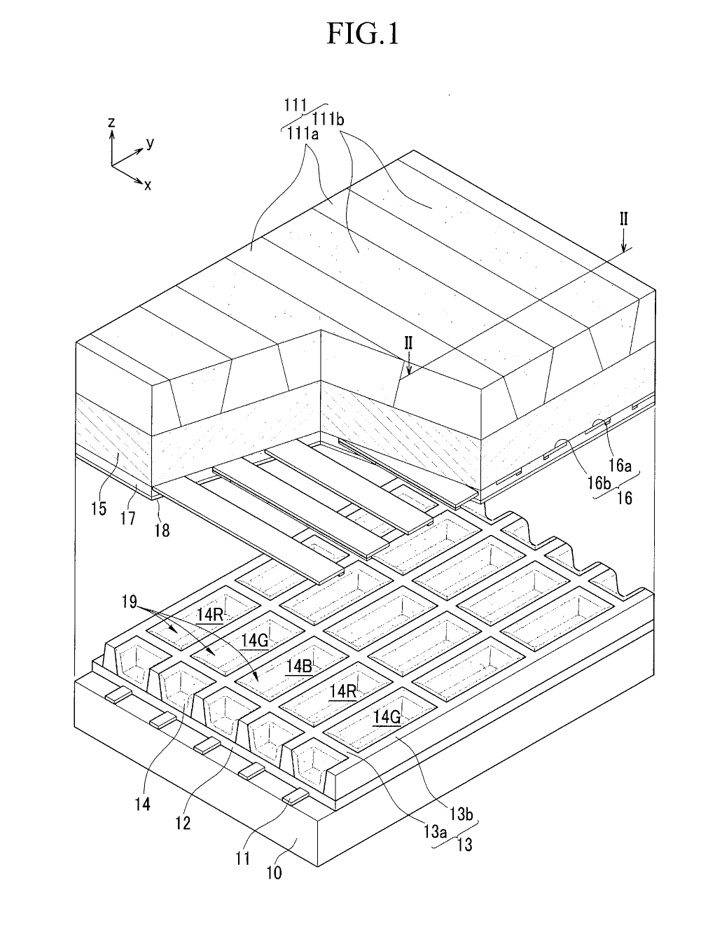

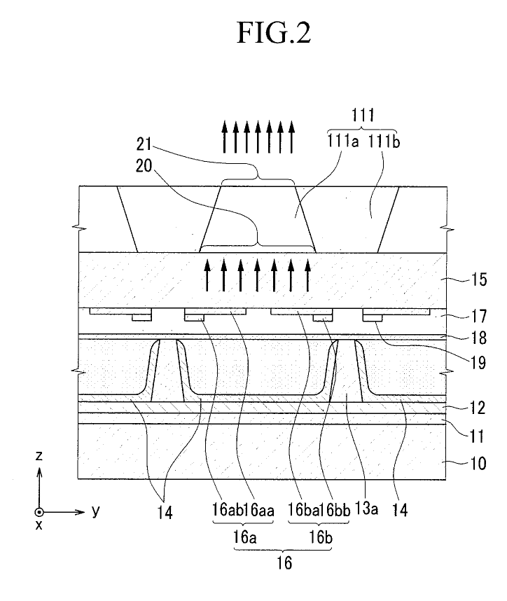

FIG. 1 is a partially exploded perspective view illustrating a plasma display panel according to a first embodiment of the present invention. FIG. 2 is a cross sectional view taken along the line II-II of FIG. 1.

As shown in FIGS. 1 and 2, the plasma display panel includes discharge cells 19, which are defined by barrier ribs 13 between rear and front substrates 10 and 15, and address and display electrodes 11 and 16 which are formed corresponding to the discharge cells 19.

The rear substrate 10 faces the front substrate 15, and the rear and front substrates 10 and 15 are parallel with each other at a distance (that may be predetermined). The address electrodes 11 extend in a first direction (i.e., a y-axis direction in FIG. 1) on an upper surface of the rear substrate 10. In addition, the address electrodes 11 are parallel with one another, and are spaced apart from one another by an interval (that may be predetermined). A rear dielectric layer 12 is formed on the upper surface (FIG. 2) of the rear substrate 10. The address electrodes 11 are covered by the rear dielectric layer 12.

As shown in FIG. 1, the display electrodes 16 extend in a second direction (i.e., an x-axis direction in FIG. 1) on a lower surface of the front substrate 15. In addition, the display electrodes 16 are parallel with one another and are spaced apart from one another by an interval (that may be predetermined).

As shown in FIG. 2, the display electrodes 16 include scan electrodes 16b and sustain electrodes 16a. The scan electrodes 16b include bus electrodes 16bb and transparent electrodes 16ba. The sustain electrodes 16a include bus electrodes 16ab and transparent electrodes 16aa. The transparent electrodes 16aa and 16ba are spaced apart from one another by a distance (that may be predetermined). Accordingly, discharge gaps corresponding to the discharge cells 19 are formed. The transparent electrodes 16aa and 16ba generates discharge in the discharge gap.

The sustain electrodes 16a and the scan electrodes 16b include transparent electrodes 16aa and 16ba to increase the area of the display electrodes 16 that is transparent. Since the transparent electrodes 16aa and 16ba have high resistance, the transparent electrodes 16aa and 16ba have low conductivity. On the other hand, the bus electrodes 16ab and 16bb are made of a metal, such as silver (Ag) or Cr/Cu/Cr, which has high conductivity.

As shown in FIG. 2, a front dielectric layer 17 is formed under the front substrate 15. The display electrodes 16 are covered with the front dielectric layer 17. The front dielectric layer 17 protects the display electrodes 16 against discharge. The wall charges are accumulated in the front dielectric layer 17.

The front dielectric layer 17 is further covered with a protective layer 18. The protective layer 18 is made of a transparent material. The protective layer 18 transmits visible light emitted from the fluorescent layer 14 and protects the front dielectric layer 17 against discharge. The protective layer 18 lowers a firing voltage level by increasing a secondary electron emission coefficient. In an embodiment of the present invention, the protective layer 18 is made of magnesium oxide (MgO).

As shown in FIG. 1, barrier ribs 13 are formed between the protective layer 18 and the rear dielectric layer 12. The barrier ribs 13 include transversal barrier ribs 13a and longitudinal barrier ribs 13b. The transversal barrier ribs 13a extend in a second direction (i.e., an x-axis direction in FIG. 1). The longitudinal barrier ribs 13b extend in a first direction (i.e., a y-axis direction in FIG. 1). The longitudinal barrier ribs 13b cross the transversal barrier ribs 13a. In one embodiment of the present invention, the longitudinal and transversal barrier ribs 13a and 13b define the discharge cells 19 in a lattice shape.

The discharge cells 19 according to other embodiments of the present invention may have various shapes such as a stripe or delta shape. The barrier ribs 13 prevent crosstalk among the discharge cells 19. The barrier ribs 13 provide surfaces to be coated with the fluorescent layer 14.

The discharge cells 19 are filled with discharge gas that is inert gas (for example, a mixture of neon (Ne) and xenon (Xe)). The discharge gas generates discharge between the sustain electrodes 16a and scan electrodes 16b. Vacuum ultraviolet rays emitted from the discharge excite the fluorescent layer 14, thereby emitting visible light.

Referring to FIGS. 1 and 2, a filter 111 is formed on the front substrate 15. The filter 111 includes light guides 111a and non-glare members 111b. The light guides 111a and the non-glare members 111b extend in the second direction (i.e., an x-axis direction in FIGS. 1 and 2). The light guides 111a and the non-glare members 111b are disposed in parallel with each other.

The light guides 111a include incident surfaces 20 and emitting surfaces 21. Light emitted from the discharge cells 19 is incident on the incident surfaces 20. The light incident on the incident surfaces 20 passes to the outside of the filter 111 through the emitting surfaces 21.

As shown in FIG. 2, the area (or areas) of the emitting surfaces 21 is smaller than the area (or areas) of the incident surfaces 20. The light incident on the incident surfaces 20 is gathered (or focused) by passing through the light guides 111a and the emitting surfaces 21 due to the aforementioned structure. As a result, the panel displays more detailed images. Further, since the non-glare member 111b absorbs (e.g., with relative ease) external light, the light reflected from the panel is reduced.

Super high definition images with high-pixel resolution can be displayed on the plasma display panel with the filter 111. Further, contrast is effectively maintained even in a bright room condition.

Light is not easily absorbed at the interfaces between the light guides 111a and the non-glare members 111b. Accordingly, the light does not easily disappear. The emitting surfaces 21 of the light guides 111a have a non-glare coating, so the light reflected from the plasma display panel is further reduced.

The front dielectric layer 17 according to the first embodiment of the present invention is colored with a first color (e.g., a first chromatic color). The non-glare members 111b are colored with a second color (e.g., a second chromatic color). The bus electrodes 16ab and 16bb are colored with a third color (e.g., a third chromatic color). In addition, the first to third colors are in a subtractive color mixture relationship.

By way of example, in one embodiment of the present invention, the second color of the non-glare members 111b and the third color of the bus electrodes 16ab and 16bb are in a first complementary color relationship. The third color of the bus electrodes 16ab and 16bb and the first color of the front dielectric layer 17 are in a second complementary relationship. As such, the non-glare members 111b, the bus electrodes 16ab and 16bb, and the front dielectric layer 17 are in a double complementary color relationship.

In an embodiment of the present invention, the bus electrodes 16ab and 16bb are formed as a single layer. In other embodiments, when the bus electrodes 16ab and 16bb include a black layer (not shown) and a white layer (not shown), the processes of manufacturing the bus electrodes may be complicated. When the bus electrodes 16ab and 16bb include a plurality of layers, such as a black layer and a white layer, edge curl may occur since the materials of the layers are different.

In an embodiment of the present invention, the bus electrodes 16ab and 16bb are formed as a single layer made of the same material, so the processes of manufacturing the bus electrodes 16ab and 16bb may be simplified. When patterns are exposed to light in order to form the bus electrodes 16ab and 16bb, the patterns are uniformly exposed to the light and developed by using a developer, thereby reducing undercut. In addition, since the bus electrodes 16ab and 16bb are formed as a single layer and made of the same material, edge curl less frequently occurs in the drying and annealing processes.

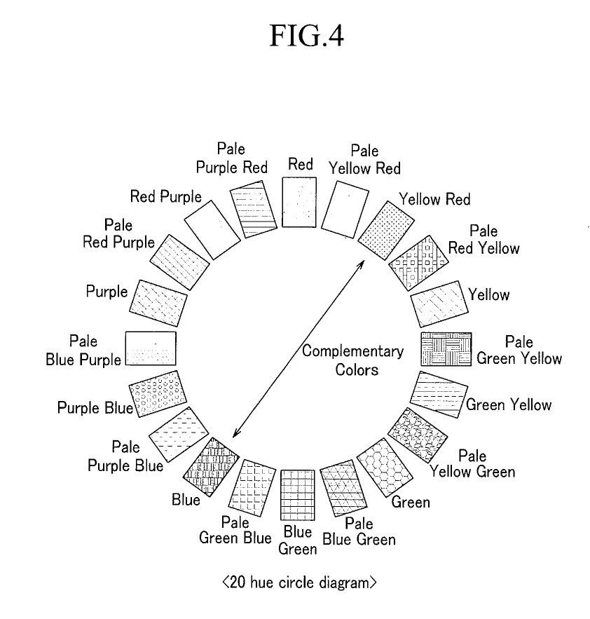

Types and relationships among the first color of the front dielectric layer 17, the second color of the non-glare member 111b, and the third color of the bus electrodes 16ab and 16bb will be described in detail with reference to FIG. 4.

In an embodiment of the present invention, the light guides 111a and the non-glare members 111b may extend in the second direction (i.e., the x-axis direction in FIG. 2). In another embodiment, the light guides 111a and the non-glare members 111b may extend in the first direction (i.e., the y-axis direction in FIG. 2). In an embodiment of the present invention, the non-glare members 111b have a stripe shape. In another embodiment, the non-glare members 111b may have a lattice shape.

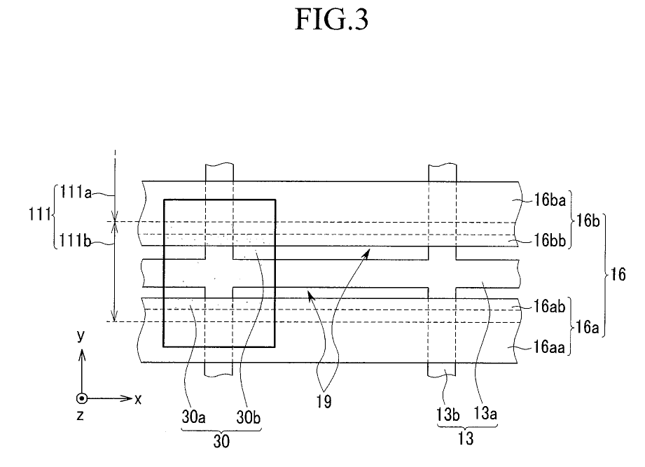

FIG. 3 is a partial top plan view illustrating an image display region of the plasma display panel according to a first embodiment of the present invention.

The first embodiment of the present invention will be described in detail with reference to FIG. 3. Like reference numerals designate like elements throughout the specification. Descriptions that are mere repeats of the descriptions previously given may be omitted.

As shown in FIG. 3, the sustain and scan electrodes 16a and 16b are paired and extend in the second direction (i.e., the x-axis in FIG. 3) along the discharge cells 19. The bus electrodes 16ab and 16bb are disposed along the transparent electrodes 16aa and 16ba, respectively.

The plasma display panel includes an image display region 30 on which images are displayed. In FIG. 3, only a part of the image display region 30 is shown. The image display region 30 includes a first region 30a, where the bus electrodes 16ab and 16bb are visible through the non-glare member 111b, and a second region 30b, where the front dielectric layer 17 is visible through the light guides 111a.

According to an embodiment of the present invention, when the second color of the non-glare members 111b is blue, and the third color of the bus electrodes 16ab and 16bb are yellow red, a part where the non-glare members 111b overlap the bus electrodes 16ab and 16bb appears black or substantially black. When the third color of the bus electrodes 16ab and 16bb is yellow red, and the first color of the front dielectric layer 17 is blue, a part where the bus electrodes 16ab and 16bb overlap the front dielectric layer 17 appears black or substantially black. Accordingly, a black area ratio of the plasma display panel increases, thereby improving the bright room contrast.

As described above, the first region 30a is a region where the non-glare members 111b, the bus electrodes 16ab and 16bb, and the front dielectric layer 17 overlap. Therefore, the first region 30a is in a double complementary color relationship.

According to an embodiment of the present invention, in order to color the front dielectric layer 17, the non-glare members 111b, and the bus electrodes 16ab and 16bb with the first to third colors, respectively, coloring agents may be added to the front dielectric layer 17, the non-glare members 111b, and the bus electrodes 16ab and 16bb. The coloring agents may coat the surfaces of the front dielectric layer 17, the non-glare members 111b, and the bus electrodes 16ab and 16bb or may be mixed into the respective raw materials used to form the front dielectric layer 17, the non-glare members 111b, and the bus electrodes 16ab and 16bb.

In order to be colored a shade of blue, a material selected among manganese (Mn), nickel (Ni), cobalt (Co), and combinations thereof, may be added to the layer to be colored blue or may coat the layer to be colored blue. In order to be colored a shade of yellow red, a material selected among copper (Cu), antimony (Sb), chromium (Cr), and combinations thereof, may be added to the layer to be colored yellow red or may coat the layer to be colored yellow red.

FIG. 4 is a hue circle for illustrating complementary color relationships.

Two colors which may be mixed to form black or gray are in a complementary color relationship. As shown in FIG. 4, blue and yellow red are in a complementary color relationship. Red and cyan (e.g., blue green) are in a complementary color relationship. Purple and green yellow are in a complementary relationship. Although black and white are not shown in the hue circle, black and white are in a complementary relationship. An infinite number of pairs of colors are in respective complementary relationships.

Even if colors are not in a complementary relationship, when colors which are substantially in a complementary relationship are subtractively mixed, the subtractive color mixture appears substantially black and absorbs light. For example, in FIG. 4, yellowish red (e.g., pale yellow red) and blue are not in a complementary color relationship. However, yellowish red is adjacent to yellow red, which is the complementary color of blue. Accordingly, blue and yellowish red together appear substantially black when they are subtractively mixed.

In an embodiment of the present invention, when the second color of the non-glare members 111b is a shade of blue, the third color of the bus electrodes 16ab and 16bb may be a shade of yellow red that is the complementary color of blue. In addition, the first color of the front dielectric layer 17 may be a shade of blue that is the complementary color of yellow red. Further, when the second color of the non-glare member 111b is a shade of yellow red, the third color of the bus electrodes 16ab and 16bb may be a shade of blue that is the complementary color of yellow red. The first color of the front dielectric layer 17 may be a shade of yellow red that is the complementary color of blue.

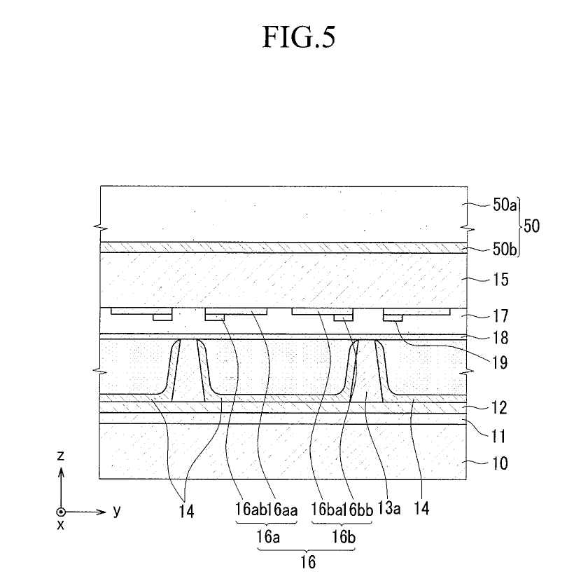

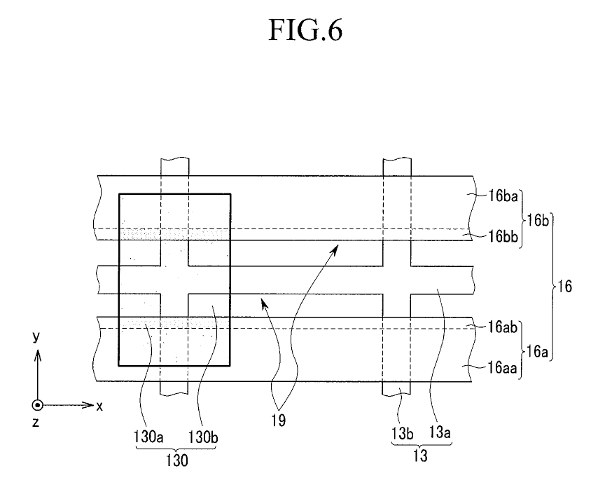

FIG. 5 is a partial cross sectional view illustrating a plasma display panel according to a second embodiment of the present invention. FIG. 6 is a partial top plan view illustrating an image display region of the plasma display panel according to the second embodiment of the present invention.

The second embodiment of the present invention will be described in detail with reference to FIGS. 5 and 6. Like reference numerals designate like elements throughout the specification. Descriptions that are mere repeats of the descriptions previously given in reference to other embodiments may be omitted.

A filter 50 is formed on the front substrate 15. The filter 50 includes a conductive film 50b and a non-glare layer 50a, with the conductive film 50b formed on the front substrate 15. In the filter 50, the non-glare layer 50a is formed on the conductive film 50b. The conductive film 50b may be made of indium tin oxide (ITO) or mesh type copper. One side of the conductive film is grounded to a ground member.

The conductive film 50b reduces electromagnetic interference (EMI) generated in the panel by absorbing the EMI. The non-glare layer 50a may be relatively non-conductive, as compared with the conductive film 50b.

The front dielectric layer 17 according to an embodiment of the present invention is colored with the first color. The non-glare layer 50a is colored with a fourth color (e.g., fourth chromatic color). The bus electrodes 16ab and 16bb are colored with the third color. In addition, the first color, the fourth color, and the third color are in a subtractive color mixture relationship.

In an embodiment of the present invention, the fourth color of the non-glare layer 50a and the third color of the bus electrodes 16ab and 16bb are in a first complementary color relationship. The third color of the bus electrodes 16ab and 16bb and the first color of the front dielectric layer 17 are in a second complementary color relationship. As such, the non-glare layer 50a, the bus electrodes 16ab and 16bb, and the front dielectric layer 17 are in a double complementary color relationship. Further, as described above, the bus electrodes 16ab and 16bb may be formed as a single layer.

As shown in FIG. 6, the plasma display panel includes the image display region 130 on which images are displayed. In FIG. 6, only a part of the image display region 130 is shown. The image display region 130 includes the first region 130a, where the bus electrodes 16ab and 16bb are visible through the filter 50, and the second region 130b, where the front dielectric layer 17 is visible through the filter 50.

According to the second embodiment of the present invention, when the fourth color of the non-glare layer 50a is blue and the third color of the bus electrodes 16ab and 16bb is yellow red, a part where the non-glare layer 50a overlaps the bus electrodes 16ab and 16bb appears black or substantially black. In addition, when the third color of the bus electrodes 16ab and 16bb is yellow red, and the first color of the front dielectric layer 17 is blue, a part where the bus electrodes 16ab and 16bb overlap the front dielectric layer 17 appears black or substantially black. Accordingly, the black area ratio of the plasma display panel increases, thereby improving the bright room contrast.

As shown in FIG. 6, the second region 130b is in the single complementary color relationship.

In the second embodiment of the present invention, the bus electrodes 16ab and 16bb may be formed as a single layer. Since the bus electrodes 16ab and 16bb include a black layer (not shown) and a white layer (not shown), the processes of manufacturing the bus electrodes may be complicated.

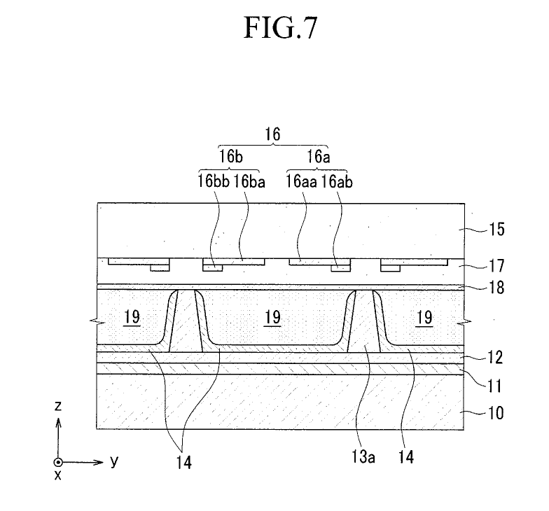

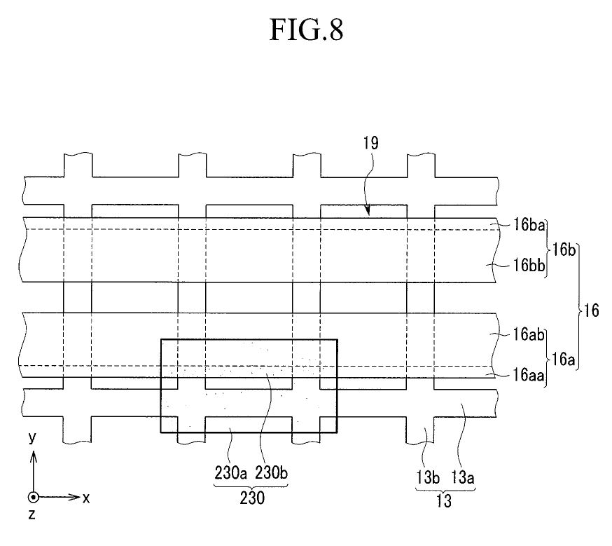

FIG. 7 is a partial cross sectional view illustrating a plasma display panel according to a third embodiment of the present invention. FIG. 8 is a top plan view illustrating an image display region of the plasma display panel according to the third embodiment of the present invention.

The third embodiment of the present invention will be described in detail with reference to FIGS. 7 and 8. Like reference numerals designate like or similar elements throughout the specification. Descriptions that are mere repeats of the descriptions previously given in reference to other embodiments may be omitted.

The front dielectric layer 17, according to the third embodiment of the present invention is colored with the first color. The front substrate 15 is colored with a fifth color (e.g., a fifth chromatic color). The bus electrodes 16ab and 16bb are colored with the third color. The first color, the fifth color, and the third color are selected to be in a subtractive color mixture relationship.

In the third embodiment of the present invention, the fifth color of the front substrate 15 and the third color of the bus electrodes 16ab and 16bb are in a first complementary color relationship. The third color of the bus electrodes 16ab and 16bb and the first color of the front dielectric layer 17 are in a second complementary relationship. As such, the front substrate 15, the bus electrodes 16ab and 16bb, and the front dielectric layer 17 are in a double complementary color relationship. Further, the bus electrodes 16ab and 16bb may be formed as a single layer.

As shown in FIG. 8, the plasma display panel includes an image display region 230 on which images are displayed. In FIG. 8, only a part of the image display region 230 is shown. The image display region 230 includes a first region 230a, where the bus electrodes 16ab and 16bb are visible through the front substrate 15, and a second region 230b, where the front dielectric layer 17 is visible through the front substrate 15.

According to the third embodiment of the present invention, when the fifth color of the front substrate 15 is blue, the third color of the bus electrodes 16ab and 16bb is yellow red, a part where the front substrate 15 overlaps the bus electrodes 16ab and 16bb represents black or substantially black. In addition, when the third color of the bus electrodes 16ab and 16bb is yellow red, and the first color of the front dielectric layer 17 is blue, a part where the bus electrodes overlap the front dielectric layer 17 represents black or substantially black. Accordingly, the light reflected from of the plasma display panel decreases, thereby improving the black area ratio and the bright room contrast.

As shown in FIG. 8, the first region 230a is in a double complementary color relation.

In the third embodiment of the present invention, the bus electrodes 16ab and 16bb may be formed as a single layer. Since the bus electrodes 16ab and 16bb include a black layer (not shown) and a white layer (not shown), the processes of manufacturing the bus electrodes may be complicated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a front substrate;
a rear substrate facing the front substrate and spaced apart from the front substrate;
a plurality of address electrodes extending in a first direction on the rear substrate;
a plurality of barrier ribs between the front substrate and the rear substrate, the barrier ribs defining a plurality of discharge cells;
a plurality of display electrodes extending in a second direction crossing the first direction and corresponding to the discharge cells, wherein the display electrodes comprise bus electrodes colored a third chromatic color;
a dielectric layer on the front substrate, the dielectric layer covering the display electrodes and colored a first chromatic color that is in a subtractive color mixture relationship with the third chromatic color; and
a filter disposed on an outer surface of the front substrate, the filter comprising:
a plurality of light guides comprising incident surfaces and emitting surfaces, wherein areas of the incident surfaces are larger than areas of the emitting surfaces; and
a plurality of non-glare members that are adjacent to the light guides and colored a second chromatic color.

2. The plasma display panel of claim 1, wherein the second chromatic color and the third chromatic color are in a complementary color relationship.

3. The plasma display panel of claim 1, wherein the third chromatic color and the first chromatic color are in a complementary color relationship.

4. The plasma display panel of claim 1, wherein the second chromatic color is a shade of blue.

5. The plasma display panel of claim 4, wherein the dielectric layer is colored a shade of blue by adding at least one of manganese (Mn), nickel (Ni), or cobalt (Co) to the dielectric layer.

6. The plasma display panel of claim 1, wherein the third chromatic color is a shade of yellow red.

7. The plasma display panel of claim 6, wherein the dielectric layer is colored a shade of yellow red by adding at least one of copper (Cu), antimony (Sb), or chromium (Cr) to the dielectric layer.

8. The plasma display panel of claim 1, wherein the bus electrodes comprises a single layer.

9. A plasma display panel comprising:
a front substrate;
a rear substrate facing the front substrate and spaced apart from the front substrate;
a plurality of address electrodes extending in a first direction on the rear substrate;
a plurality of barrier ribs between the front substrate and the rear substrate and defining a plurality of discharge cells; a plurality of display electrodes extending in a second direction crossing the first direction, wherein the display electrodes comprise bus electrodes colored a third chromatic color;
a dielectric layer covering the display electrodes and colored a first chromatic color that is in a subtractive color mixture relationship with the third chromatic color; and
a filter on an outer surface of the front substrate, the filter comprising:
a conductive film on the outer surface of the front substrate; and
a non-glare layer on the conductive film and colored a second chromatic color.

10. The plasma display panel of claim 9, wherein the conductive film comprises ITO (indium tin oxide) or Copper (Cu), and one side of the conductive film is electrically connected to a ground member.

11. The plasma display panel of claim 9, wherein the second chromatic color and the third chromatic color are in a complementary color relationship.

12. The plasma display panel of claim 9, wherein the third chromatic color and the first chromatic color are in a complementary color relationship.

13. A plasma display panel comprising:
a rear substrate;
a front substrate facing the rear substrate, the front substrate spaced apart from the rear substrate and colored a second chromatic color;
a plurality of address electrodes extending in a first direction on the rear substrate;
a plurality of barrier ribs between the front substrate and the rear substrate and defining a plurality of discharge cells;
a plurality of display electrodes extending in a second direction crossing the first direction and corresponding to the discharge cells, wherein the display electrodes comprise bus electrodes colored a third chromatic color; and
a dielectric layer covering the display electrodes and colored a first chromatic color in a subtractive color mixture relationship with the third chromatic color.

14. The plasma display panel of claim 13, wherein the second chromatic color and the third chromatic color are in a complementary color relationship.

15. The plasma display panel of claim 13, wherein the third chromatic color and the first chromatic color are in a complementary color relationship.
